(19) United States
(12) Patent Application Publication
(10) Pub. No.: US 2023/0191459 A1
(43) Pub. Date: Jun. 22, 2023

(54) A CONTACT CLEANING SURFACE

(71) Applicant: Illinois Tool Works Inc., Glenview, IL (US)

(72) Inventors: Sheila Hamilton, Glasgow (GB); Stephen Frank Mitchell, Glasgow (GB)

(21) Appl. No.: 17/926,190

(22) PCT Filed: May 6, 2021
(86) PCT No.: PCT/US2021/031089

§ 371 Date: Nov. 18, 2022

(30) Foreign Application Priority Data
Jun. 2, 2020 (GB) 2008240.0

(51) Int. Cl. B08B 1/00; B08B 7/00

(52) U.S. Cl. CPC B08B 1/007; B08B 7/0028

(57) ABSTRACT

There is provided a contact cleaning surface (10), for a contact cleaning roller, configured to collect and/or remove contaminating particles from a contaminated substrate, including a frame defining a plurality of recessed cells (14), the frame having at least one wall defining the perimeter of each cell, the at least one wall having a pair of parallel opposing surfaces upstanding substantially perpendicularly from a base and terminating in a contact surface configured to contact the contaminated substrate, the at least one wall having a cross-sectional area that is substantially the same between said base and said contact surface. There is also provided a contact cleaning and an apparatus, each configured to collect and/or remove contaminating particles from a contaminated substrate, and method of collecting and/or removing contaminating particles from a contaminated substrate.

### RELATED APPLICATIONS

The present application claims the benefit of United Kingdom (GB) Patent Application No. 2008240.0, filed Jun. 2, 2020, entitled “A CONTACT CLEANING SURFACE.” The entirety of United Kingdom (GB) Patent Application No. 2008240.0 is expressly incorporated herein by reference.

### FIELD OF THE DISCLOSURE

The present invention relates to a contact cleaning surface. In particular, but not exclusively, the present invention relates to a contact cleaning surface for a contact cleaning roller that is configured to collect and/or remove contaminating particles from a contaminated substrate. The present invention also relates to a contact cleaning roller, a contact cleaning apparatus, and a method for collecting and/or removing contaminating particles from a contaminated substrate.

### BACKGROUND OF THE INVENTION

Contact cleaning is used to clean substrate surfaces. Once cleaned, the substrate surfaces may be used in a variety of sophisticated processes such as in the manufacturing of electronics, photovoltaics and flat panel displays. Usually, a rubber or elastomeric cleaning roller is used to remove the contaminating particles from a contaminated substrate, and an adhesive roll can then be used to remove the contaminating particles from the cleaning roller. This allows the cleaning roller to maximise its efficiency in removing contaminating particles.

Referring to FIG. 1(a), oftentimes, rubber or elastomeric cleaning rollers have a surface 1 that may be microscopically roughened, into which contaminating particles are received from the contaminated substrate. However, such a microscopically roughened surface 1 includes a number of asperities 2, defining a series of troughs 3 for receiving contaminating particles therein, having a footprint, or a cross-sectional area or profile, that is irregular from a contact surface to a base of the cleaning surface 1. During use, the rubber or elastomeric cleaning roller wears as the microscopically roughened surface 1 contacts the contaminated substrate at its outer extremity. In this way, and as shown in FIG. 1(b), due to the irregular cross-sectional area of the asperities 2 formed in the microscopically roughened surface 1, the rubber or elastomeric roller wears in an inconsistent manner across the surface of the roller. That is to say, the surface contact area of the cleaning surface 1 changes as the roller wears, as can be seen by comparing FIGS. 1(a) and 1(b). Thus, cleaning performance may vary considerably across the surface of the rubber or elastomeric cleaning roller as it wears during use. Changes in the surface area of the cleaning surface during use are problematic not only because of the inconsistency in cleaning performance but also in applications where the substrate is a film, for example. Increasing or decreasing the cleaning surface area changes the adhesion forces between the roller and the film and may causing wrapping of the film around the roller.

Therefore, it is an object of at least one aspect of the present invention to obviate or mitigate the aforementioned problems. In particular, it is an object of at least one aspect of the present invention to provide a contact cleaning surface that wears evenly during use, thus ensuring consistent cleaning performance as the surface wears.

### SUMMARY OF THE INVENTION

According to one aspect of the present invention, there is provided a contact cleaning surface, for a contact cleaning roller, configured to collect and/or remove contaminating particles from a contaminated substrate, comprising:

a polymeric layer defining a contact surface; and

at least one cell recessed into said polymeric layer, said at least one cell comprising a base and at least one wall extending between said contact surface and said base, wherein said at least one wall extends perpendicularly to said contact surface.

This provides the advantage that the contact cleaning surface wears evenly during use. In this way, consistent cleaning performance is maintained as the contact cleaning surface wears during use.

In certain embodiments, said base extends perpendicularly to said at least one wall.

In certain embodiments, said base and said contact surface are substantially parallel surfaces. Yet more specifically, the at least one wall extends between the base and the contact surface substantially perpendicular to both the base and the contact surface.

In certain embodiments, a ratio between a surface area of said contact surface and a surface area of said base remains substantially the same as said contact surface contacts the contaminated substrate and wears during use.

In certain embodiments, the surface area of said contact surface is in the range 10% to 80% of the total surface area of said contact cleaning surface.

This provides the advantage that a contaminated substrate can be cleaned with optimal efficiency.

That is, in some embodiments, said contact surface forms from 10% to 80% of the total surface area of said contact cleaning surface. In other words, the footprint of the contact surface forms from 10% to 80% of the total surface area of said contact cleaning surface.

In some embodiments, the total surface area of said contact surface is from 10%, 20%, 30%, 40%, 50%, 60% or 70% to 20%, 30%, 40%, 50%, 60%, 70% or 80%. In some embodiments, the range may include a lower limit of any integer between 10% and 79%. In some embodiments, the range may include an upper limit of any integer between 11% and 80%.

In certain embodiments, said at least one cell has a substantially circular and/or substantially polygonal footprint.

In some embodiments, said at least one cell has a substantially circular, triangular, square, rectangular or pentagonal footprint. Other polygonal footprints are contemplated.

Preferably, said at least one cell has a substantially hexagonal footprint.

In certain embodiments, the contact cleaning surface comprises a plurality of cells each recessed into the polymeric layer each cell being spaced apart by a portion of said contact surface.

In certain embodiments, each of the plurality of cells has a substantially hexagonal footprint. In this way, the plurality of recessed, cells form a substantially honeycomb-like structure.

The honey-comb structure provides the advantage that a contaminated substrate can be cleaned with optimal efficiency. More specifically, hexagonal cells provide a contact surface which is substantially the same width (measured between the opposing walls), i.e. consistent, across the surface of the roller. Moreover, a hexagonal footprint provides optimum packing density across the surface of the roller.

In certain embodiments each of the plurality of cells recessed into said polymeric layer comprises a base and at least one wall extending between said contact surface and said base, wherein said at least one wall extends perpendicularly to said contact surface.

In certain embodiments, each of the plurality of cells recessed into said polymeric layer comprises a base and six walls together forming a hexagonal footprint cell, each wall extending between said contact surface and said base, wherein each wall extends perpendicularly to said contact surface.

In certain embodiments, said base extends perpendicularly to each of the six walls.

In some embodiments, at least a portion, preferably substantially all or each, of the plurality of recessed cells has substantially the same depth. In other embodiments, at least a portion, preferably substantially all or each, of the plurality of recessed cells has a substantially different depth.

In some embodiments, at least a portion, preferably substantially all or each, of the plurality of recessed cells has substantially the same width, or cross-sectional diameter. In other embodiments, at least a portion, preferably substantially all or each, of the plurality of recessed cells has a substantially different width, or cross-sectional diameter.

In some embodiments, at least a portion, preferably substantially all, of said plurality of recessed cells have a substantially circular and/or substantially polygonal footprint. In particular embodiments, at least a portion, preferably substantially all, of said plurality of recessed cells have a substantially circular, triangular, square, rectangular and/or pentagonal footprint. Other polygonal footprints are contemplated.

In some embodiments, at least a portion, preferably substantially all, of said plurality of recessed cells have approximately the same footprint.

This provides the advantage that the contact cleaning surface is easier and less expensive to manufacture. This provides the further advantage that the contact surface area is consistent across substantially the whole surface of the roller.

In other embodiments, at least a portion, preferably substantially all, of said plurality of recessed cells may have varying footprints.

This provides the advantage that contaminating particles of varying size and shape may be collected by the contact cleaning surface.

In certain embodiments, at least a portion of said plurality of recessed cells are uniformly distributed across at least a portion of said contact cleaning surface.

Preferably, substantially all of said plurality of recessed cells are uniformly distributed across substantially all of said contact cleaning surface.

This provides the advantage that consistent cleaning performance is provided across the area of the contact cleaning surface.

In certain embodiments, said at least one cell has a depth of less than or equal to about 100 microns. That is, the vertical distance between the base of the recessed cell to the contact surface, is less than or equal to about 100 microns.

In some embodiments, said at least one cell has a depth of less than or equal to about 100, 90, 80, 70, 60, 50, 40, 30, 20 or 10 microns, or any integer therebetween.

In certain embodiments, said at least one cell has a width, or a cross-sectional diameter, of less than or equal to 100 microns. That is, the lateral distance between diametrically opposing points on the walls of the recessed cell is less than or equal to 100 microns.

In some embodiments, said at least one recessed cell has a width, or a cross-sectional diameter, of less than or equal to about 100, 90, 80, 70, 60, 50, 40, 30, 20, 10 or 1 micron, or any integer therebetween.

In certain embodiments, said at least one cell may be of a size and shape that about 20%, 30%, 40%, 50%, 60%, 70% or 80% of the volume of contaminating particles may fit into the recessed cells of the contact cleaning surface. This means about 20%, 30%, 40%, 50%, 60%, 70% or 80% of the total surface area of the contaminating particles may be in contact with the contact cleaning surface as they are collected and/or removed from the contaminated substrate.

In certain embodiments, said polymeric layer comprises a rubber or an elastomeric material.

In certain embodiments, a portion, preferably substantially all, of the contact cleaning surface is textured, or may have a surface topography, to provide the plurality of recessed cells. The contact cleaning surface may be textured using any suitable mechanical and/or chemical technique, including suitable mechanical means, moulding means and/or laser structuring means.

According to another aspect of the present invention, there is provided a contact cleaning roller, configured to collect and/or remove contaminating particles from a contaminated substrate, comprising a roll core having a contact cleaning surface as described herein.

In certain embodiments, said roll core defines a longitudinal axis, and wherein said at least one wall extends substantially perpendicularly to said longitudinal axis.

According to yet another aspect of the present invention, there is provided a contact cleaning apparatus for collecting and/or removing contaminating particles from a contaminated substrate, comprising:

at least one contact cleaning roller comprising a roll core having a contact cleaning surface as described herein; and

at least one adhesive roll comprising a roll core having at least one layer of adhesive material thereon, said at least one adhesive roll configured to collect and/or remove contaminating particles from said contact cleaning surface of said at least one contact cleaning roller.

In certain embodiments, the contact cleaning apparatus further comprises at least one biasing element arranged to urge said contact cleaning roller against the contaminated substrate. In other embodiments, said contact cleaning roller may contact the contaminated substrate by virtue of gravity.

This provides the advantage that a good face-to-face engagement or contact is achieved, during use, thereby maximising the efficiency of the contact cleaning process.

In certain embodiments, the contact cleaning apparatus comprises a pair of contact cleaning rollers and a pair of adhesive rolls, each contact cleaning roller separately configured to collect and/or remove contaminating particles from opposing surfaces of the contaminated substrate, and each adhesive roll being separately configured to collect and/or remove contaminating particles from each contact cleaning roller.

This provides the advantage that each opposing surface of the contaminated substrate may be cleaned simultaneously.

According to yet a further aspect of the present invention, there is provided a method of collecting and/or removing contaminating particles from a contaminated substrate, comprising the steps of:

providing a contaminated substrate including contaminating particles thereon;

providing a contact cleaning surface as described herein; and

contacting and/or urging said contact cleaning surface against said contaminated substrate, such that at least some or substantially all of said contaminating particles on said contaminated substrate are collected and/or removed.

In certain embodiments, the method comprises the step of providing at least one contact cleaning roller comprising a roll core having said contact cleaning surface thereon.

In certain embodiments, the method comprises the steps of:

providing at least one adhesive roll comprising a roll core having at least one layer of adhesive material thereon;

contacting and/or urging said at least one adhesive roll against said at least one contact cleaning roller, such that at least some or substantially all of said contaminating particles on said contact cleaning surface of said at least one contact cleaning roller are collected and/or removed.

In certain embodiments, the method further comprises the steps of:

providing a pair of contact cleaning rollers, each contact cleaning roller comprising a roll core having said contact cleaning surface thereon;

contacting and/or urging each contact cleaning roller of said pair of contact cleaning rollers against opposing surfaces of said contaminated substrate;

providing a pair of adhesive rolls, each adhesive roll comprising a roll core having at least one adhesive material thereon; and

contacting and/or urging one adhesive roll against one contact cleaning roller, and contacting and/or urging the other adhesive roll against the other contact cleaning roller, such that at least some or substantially all of said contaminating particles on each contact cleaning roller are collected and/or removed by each adhesive roll.

In certain embodiments, the step of contacting and/or urging said contact cleaning surface against said contaminated substrate comprises rotating said, or each, contact cleaning roller as said, or each, contact cleaning roller contacts and/or urges against said contaminated substrate, such that at least some or substantially all of said contaminating particles on said contaminated substrate are collected and/or removed.

In certain embodiments, said, or each, contact cleaning roller is rotated at a speed of 0.1 cm/s to 5.0 cm/s.

As described herein, the contaminated substrate may be a sheet or web material. More specifically, the contaminated substrate may be a film or a foil. Even more specifically, the film is a plastics material, such as polyester, polycarbonate, polyvinylchloride (PVC) or the like. Alternatively, the sheet or web material is a metallic foil. The contaminated substrate may be used in the manufacture of electronic components, such as plastic electronics, photovoltaics and flat panel displays.

Preferably, the sheet material has a thickness of less than 250 microns. Even more preferably, the sheet material has a thickness of 100 microns or less. Sheet materials having a thickness of 100 microns or less, preferably 50 microns or less, are often referred to as “thin” sheet materials.

### BRIEF DESCRIPTION OF THE DRAWINGS

Embodiments of the invention are further described hereinafter with reference to the accompanying drawings, in which:

FIG. 1 illustrates (a) a cross-sectional side view of a contact cleaning surface in accordance with the prior art before use, and (b) a cross-sectional side view of the contact cleaning surface in accordance with the prior art after a period of use;

FIG. 2 illustrates a perspective view of a contact cleaning surface in accordance with one aspect of the present invention;

FIG. 3 illustrates a cross-sectional view of the contact cleaning surface of FIG. 2 through the line A-A;

FIG. 4 illustrates the contact cleaning surface of FIG. 2 having a contaminating particle therein;

FIG. 5 illustrates (a) a cross-sectional view of the contact cleaning surface of FIG. 2 before use, through the line A-A, and (b) a cross-sectional view of the contact cleaning surface of FIG. 2 after a period of use, through the line A-A;

FIG. 6 illustrates a perspective view of a contact cleaning roller in accordance with one aspect of the present invention;

FIG. 7 illustrates a perspective view of an apparatus in accordance with one aspect of the present invention;

FIG. 8 illustrates a perspective view of an apparatus in accordance with another aspect of the present invention;

FIG. 9 illustrates a method in accordance with one aspect of the present invention; and

FIG. 10 illustrates a method in accordance with another aspect of the present invention.

### DETAILED DESCRIPTION

The present invention relates to a contact cleaning surface configured to clean and/or remove contaminating particles from a contaminated substrate. For example, the contact cleaning surface as described herein may be provided as part of a contact cleaning roller for cleaning and/or removing contaminating particles from a contaminated substrate, such as an electronic device.

Certain terminology is used in the following description for convenience only and is not limiting. The words ‘right’, ‘left’, ‘lower’, ‘upper’, ‘front’, ‘rear’, ‘upward’, ‘down’ and ‘downward’ designate directions in the drawings to which reference is made and are with respect to the described component when assembled and mounted. The words ‘inner’, ‘inwardly’, ‘outward’ and ‘outwardly’ refer to directions toward and away from, respectively, a designated centreline or a geometric centre of an element being described, such as a central axis, the particular meaning being readily apparent from the context of the description. The terms ‘distal’, ‘proximal’, ‘medial’ and ‘lateral’ designate direction of the component features according to its normal use.

Further, as used herein, the terms ‘connected’, ‘attached’, ‘coupled’ and ‘mounted’ are intended to include direct connections between two members without any other members interposed therebetween, as well as indirect connection between two members in which one or more other members are interposed therebetween. The terminology includes words specifically mentioned above, derivations thereof, and words of similar import.

Further, unless otherwise specified, the use of ordinal adjective, such as ‘first’, ‘second’, ‘third’ and the like merely indicate that difference instances of like objects are being referred to and are not intended to imply that the objects so described must be in a given sequence, either temporally, spatially, in ranking or in any other manner. Like reference numerals are used to depict like features throughout.

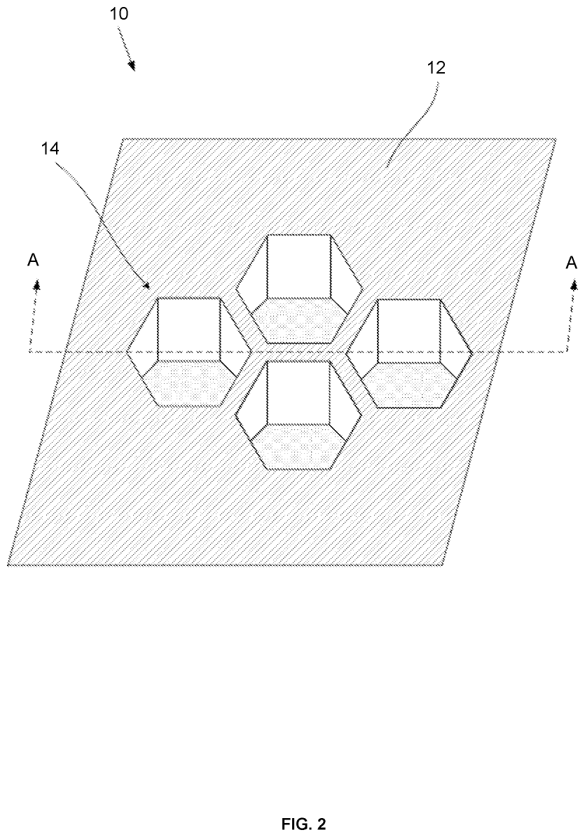

As shown in FIG. 2, a contact cleaning surface 10 having a polymeric layer defining a contact surface 12 is provided. The polymeric layer is generally composed of a rubber or an elastomeric material. Thus, the polymeric layer may be regarded as a block of rubber or elastomeric material. Other appropriate materials are equally contemplated. The contact surface 12 is generally arranged to contact a contaminated substrate in use, as described in more detail below.

A plurality of cells 14 are provided recessed into the polymeric layer. That is, in the depicted embodiment, a plurality of recessed cells 14 are provided recessed, etched, stamped or the like, into the polymeric layer. Any number of cells 14 may be provided recessed into the polymeric layer. Furthermore, each cell 14 assumes a substantially hexagonal footprint in the depicted embodiment. That is, each cell 14 is substantially hexagonal in its cross-section, or has a hexagonal cross-sectional profile, taken within a plane parallel to an axis extending substantially normal to a plane defined by the contact surface 12. Other footprints or cross-sectional profiles are contemplated, for example, a circular or any polygonal profile.

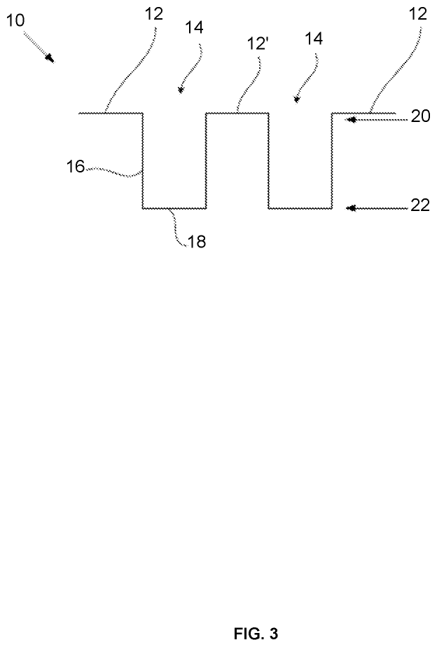

As best shown in FIGS. 2 and 3, each cell 14 includes six walls 16 and a base 18. Thus, each cell 14 includes six walls 16 defining a hexagonal footprint. Each cell 14 is recessed into the polymeric layer, such that the walls 16 extends into the polymeric layer, from a proximal end 20, adjacent and connected to the contact surface 12, to a distal end 22, which includes the base 18. Each wall 16 is perpendicular to the contact surface 12 such that the cross-sectional profile of each cell 14 is substantially the same width between the proximal end 20 and the distal end 22, thereby ensuring that the contact cleaning surface 10 wears evenly during use. Furthermore, the base 18 of each cell 14 is perpendicular to the walls 16, i.e. the base 18 and the contact surface 12 are substantially parallel. The adjacent cells 14 of the contact cleaning surface 10 are spaced apart by a portion 12′ of the contact surface 12.

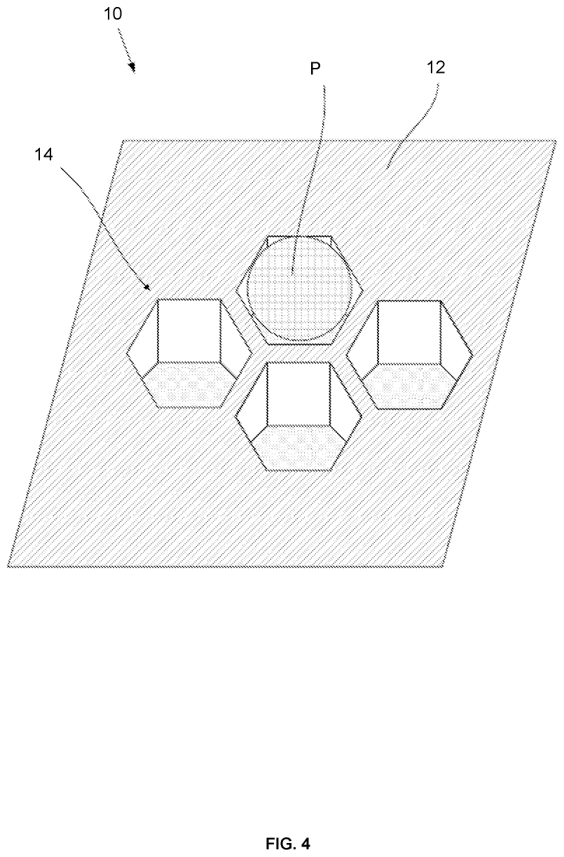

As shown in FIG. 4, during use, contaminating particles may be collected and/or removed from a contaminated substrate by the contact cleaning surface 10. In particular, each recessed cell 14 is sized, shaped or otherwise arranged such that it may collect a contaminating particle P. The contaminating particle P may be lodged entirely within the recessed cell 14 or a portion of the contaminating particle P may be in contact with the walls 16 (see FIG. 3) of the recessed cell 14 and held in place. The contaminating particle P may be of any size or shape. Generally, the recessed cells 14 may be sized and shaped to conform to a desired contaminating particle P to be removed from a contaminated surface.

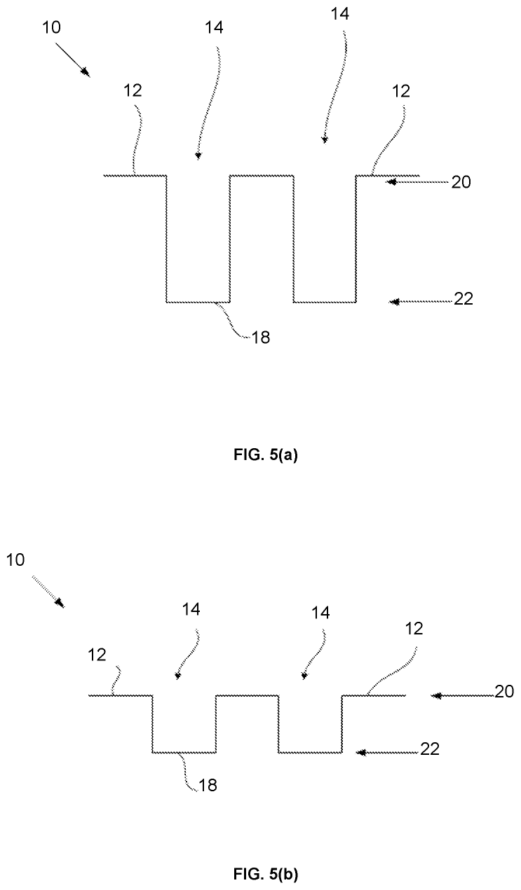

FIGS. 5(a) and 5(b) illustrate the cleaning contact surface 10 before use and after a period of use, respectively. As can be seen in these Figures, the contact cleaning surface 10 wears consistently between the proximal end 20, adjacent the contact surface 12, and the distal end 22, adjacent the base 18. In other words, the cross-sectional profile of each cell 14 remains substantially the same after a period of use. Thus, the cleaning performance of the contact cleaning surface 10 remains substantially the same throughout its lifetime.

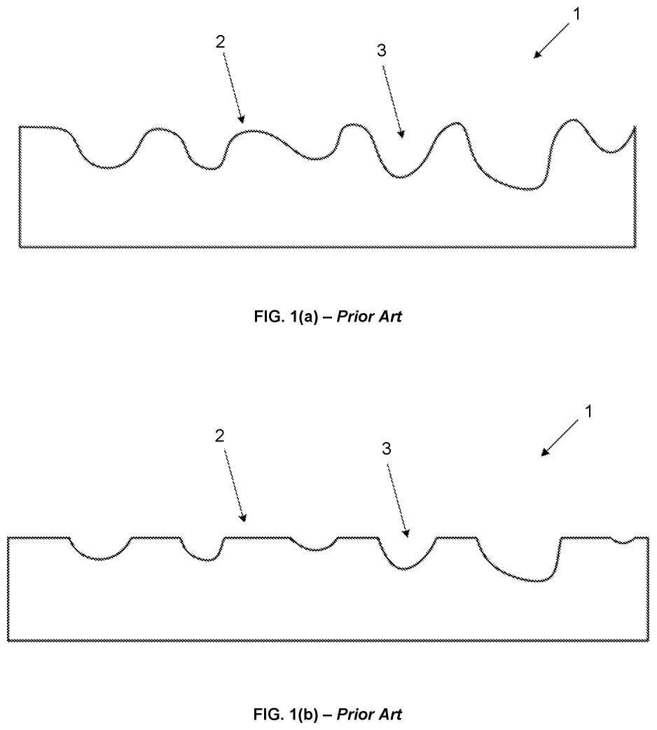

In particular, the present invention as shown in FIGS. 5(a) and 5(b) can be directly compared to the prior art, as shown in FIGS. 1(a) and 1(b). For example, after a period of use, as shown in FIGS. 1(b) and 5(b), the asperities 3 and the contact cleaning surface 10 have worn due to frictional contact between the outermost part of the contact cleaning surface 1, 10 and the contaminated substrate. In the prior art, shown in FIG. 1(a), each asperity 3 has a varying cross-sectional profile, and thus wears irregularly after a period of use, as shown in FIG. 1(b). In particular, the total surface area formed by the contact surface of the contact cleaning surface 1 increases after a period of use. This provides a non-consistent cleaning performance across the contact cleaning surface 1. On the contrary, as can be seen in FIG. 5(b), the contact cleaning surface 10 wears regularly after a period of use, and thus the total surface area formed by the contact surface of the contact cleaning surface 10 remains substantially the same after a period of use. This provides consistent cleaning performance across the contact cleaning surface 10.

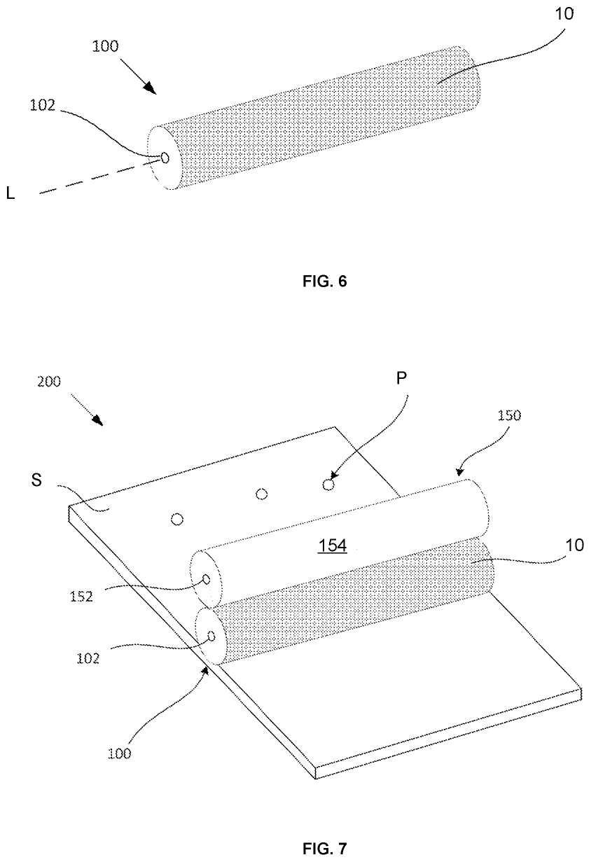

As shown in FIG. 6, a contact cleaning roller 100 is provided having a roll core 102 and a contact cleaning surface 10. The contact cleaning surface 10 is described in relation to FIGS. 2 to 4. In the depicted embodiment, substantially all of the contact cleaning surface 10 of the contact cleaning roller 100 includes a plurality of recessed cells 14, as best shown in FIG. 2. The cells 14, specifically the walls 16 thereof, generally extends inwardly and substantially normal to a longitudinal axis L defined by the roll core 102.

As shown in FIG. 7, an apparatus 200 is provided for cleaning a contaminated substrate S having a number of contaminating particles P thereon. The apparatus 200 includes a contact cleaning roller 100 as described in relation to FIG. 6. There is also provided an adhesive roll 150 comprising a roll core 152 having layers of adhesive sheeting 154. The layers of adhesive sheeting 154 may be removably attachable to the roll core 152, such that the outermost adhesive sheeting 154 may be removed once exhausted to reveal a fresh, unused, layer of adhesive sheeting 154. The contact cleaning roller 100, specifically the contact cleaning surface 10, is composed of an elastomeric material, or is coated with an elastomeric material, to facilitate removal of impurities, i.e. contaminating particles P, from a contaminated substrate S.

The contact cleaning roller 100 is rotatably mountable adjacent to the contaminated substrate S to be cleaned in such a way that allows the contact cleaning surface 10 to be in contact at a point on a surface of the contaminated substrate S. In some examples, the contact cleaning roller 100 is urged into contact with the contaminated substrate S. Hence, as the contaminated surface S is conveyed, the contact cleaning roller 100 rotates and the cleaning surface 10 of the contact cleaning roller 100 removes contaminating particles P from the contaminated substrate S. The contact cleaning roller 100 generally rotates about the longitudinal axis L (see FIG. 6) defined by the roll core 102.

The adhesive roll 150 is in rotatable contact with the contact cleaning roller 100 so as to rotate therewith, during use. The adhesive roll 150 generally rotates about a longitudinal axis defined by the roll core 152, in a similar manner as described in relation to FIG. 5. In some examples, the adhesive roll 150 may be biased towards the contact cleaning roller 100 to ensure good contact therebetween, for example, the adhesive roll core 152 may be spring-biased towards the roll core 102 of the contact cleaning roller 100. In use, the outermost adhesive sheeting 154 contacts the contact cleaning surface 10, having removed contaminating particles P, so as to clean the same and remove the contaminating particles P from the contact cleaning surface 10.

Referring further to FIG. 7, during use, the contaminated substrate S is fed into the apparatus 100 such that the contact cleaning surface 10 of the contact cleaning roller 100 contacts a portion of the contaminated substrate S. The contact cleaning surface 10 removes contaminating particles P from the contaminated surface S as it rotates, thereby cleaning the contaminated surface S. As the contact cleaning roller 100 rotates, the adhesive roll 150 rotates therewith, until a point at which the contaminating particle P collected by the contact cleaning roller 100 contacts the adhesive sheeting 154 of the adhesive roll 150. At this point, the adhesive sheeting 154 removes the contaminating particle P from the contact cleaning surface 10, thereby cleaning the same. The process is repeated until the contaminating substrate S is clean and free of contaminating particles P.

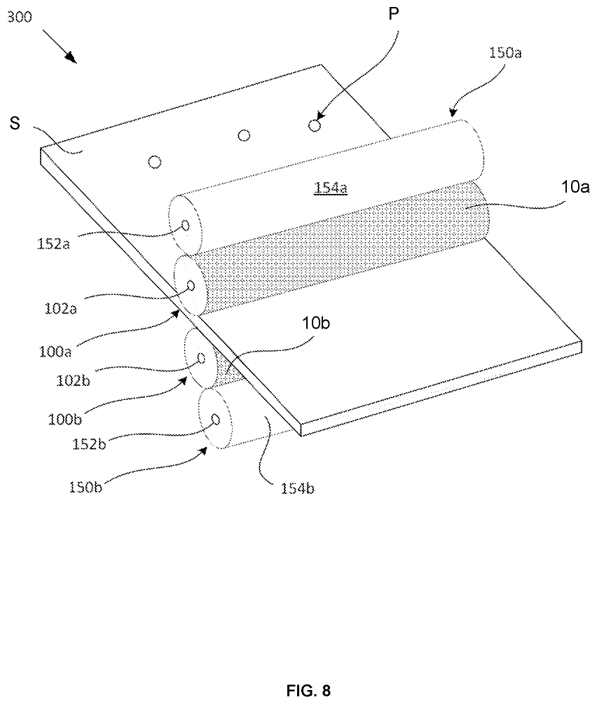

As shown in FIG. 8, another apparatus 300 is provided for cleaning a contaminated substrate S having a number of contaminating particles P thereon. The apparatus 300 includes a first contact cleaning roller 100a, having a contact cleaning surface 10a and a second contact cleaning roller 100b, having a contact cleaning surface 10b. The contact cleaning rollers 100a, 100b are as described in relation to FIG. 6. There is also provided a first adhesive roll 150a, comprising a first roll core 152a, and a second adhesive roll 150b, comprising a second roll core 152b. Each adhesive roll 150a, 150b has layers of adhesive sheeting 154a, 154b. The layers of adhesive sheeting 154a, 154b may be removably attachable to their respective roll cores 152a, 152b, such that the outermost adhesive sheeting 154a, 154b may be removed once exhausted to reveal a fresh, unused, layer of adhesive sheeting 154a, 154b. The contact cleaning rollers 100a, 100b, specifically the contact cleaning surfaces 10a, 10b, are composed of an elastomeric material, or is coated with an elastomeric material, to facilitate removal of impurities, i.e. contaminating particles P, from a contaminated substrate S.

The contact cleaning rollers 100a, 100b are rotatably mountable adjacent to the contaminated substrate S to be cleaned in such a way that allows the contact cleaning surfaces 10a, 10b to be in contact on opposing surfaces of the contaminated substrate S. In some examples, one or each contact cleaning roller 100a, 100b may be urged into contact with the contaminated substrate S. Hence, as the contaminated surface S is conveyed, the contact cleaning rollers 100a, 100b rotate and the cleaning surfaces 10a, 10b of the contact cleaning rollers 100a, 100b remove contaminating particles P from both surfaces of the contaminated substrate S. The contact cleaning rollers 100a, 100b generally rotate about the longitudinal axis L (see FIG. 6) defined by their roll cores 102a, 102b.

The adhesive rolls 150a, 150b are each in rotatable contact with a respective contact cleaning roller 100a, 100b so as to rotate therewith, during use. The adhesive rolls 150a, 150b generally rotate about a longitudinal axis L defined by their roll cores 102a, 102b, in a similar manner as described in relation to FIG. 6. In some examples, the adhesive rolls 150a, 150b may be biased towards the respective contact cleaning roller 100a, 100b to ensure good contact therebetween, for example, the adhesive roll cores 152a, 152b may each, and independently, be spring-biased towards the respective roll core 102a, 102b of the contact cleaning roller 100a, 100b. In use, each outermost adhesive sheeting 154a, 154b contacts the respective contact cleaning surface 10a, 10b, having removed contaminating particles P, so as to clean the same and remove the contaminating particles P from the contact cleaning surfaces 10a, 10b.

Referring further to FIG. 8, during use, the contaminated substrate S is fed into the apparatus 300 such that the contact cleaning surfaces 10a, 10b of the contact cleaning rollers 100a, 100b contact opposing surfaces of the contaminated substrate S. The contact cleaning surfaces 10a, 10b remove contaminating particles P from each surface of the contaminated surface S as it rotates, thereby cleaning both surfaces of the contaminated surface S. As the contact cleaning rollers 100a, 100b rotate, the adhesive rolls 150a, 150b rotate therewith, until a point at which the contaminating particle P collected by a respective contact cleaning roller 100a, 100b contacts the adhesive sheeting 154a, 154b of the respective adhesive roll 150a, 150b. At this point, the adhesive sheeting 154a, 154b removes the contaminating particle P from the respective contact cleaning surface 10a, 10b, thereby cleaning the same. The process is repeated until the contaminating substrate S is clean and free of contaminating particles P.

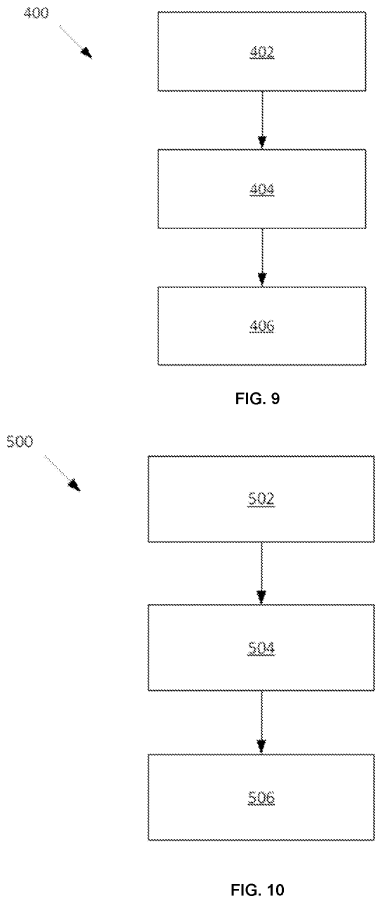

FIG. 9 illustrates a method 400 of collecting and/or removing contaminating particles P from a contaminating surface S (see FIG. 6). The method 400 starts by providing 402 a contaminated substrate S including contaminating particles P thereon (see FIG. 6). At least one contact cleaning surface is then provided 404 as described in relation to FIGS. 2 to 4. The contact cleaning surface is contacted and/or urged 406 against the contaminated substrate so as to collect and/or remove some, most or all of the contaminating particles thereon.

FIG. 10 illustrates another method 500 of collecting and/or removing contaminating particles P from opposing sides of a contaminating surface S (see FIG. 8). The method 500 starts by providing 502 a contaminated substrate S including contaminating particles P on opposing surfaces thereof (see FIG. 8). A pair of contact cleaning surfaces are then provided 504, each being as described in relation to FIGS. 2 to 4. Each contact cleaning surface is, independently, contacted and/or urged 506 against opposing surfaces of the contaminated substrate so as to collect and/or remove some, most or all of the contaminating particles thereon.

It will be appreciated by persons skilled in the art that the above embodiments have been described by way of example only and not in any limitative sense, and that various alterations and modifications are possible without departing from the scope of the invention as defined by the appended claims. Various modifications to the detailed designs as described above are possible, for example, variations may exist in the number, shape, size, arrangement, assembly or the like of contact cleaning surfaces, contact cleaning rollers or adhesive rolls. In particular, the cross-sectional profile of each recessed cell may assume any appropriate footprint, shape or size. The contact cleaning surfaces, contact cleaning rollers or adhesive rolls may be manufactured in accordance with appropriate methods using appropriate materials, as would be recognised by those skilled in the art.

1-15. (canceled)

16. A contact cleaning surface, for a contact cleaning roller, configured to collect and remove contaminating particles from a contaminated substrate, the contact cleaning surface comprising:
a polymeric layer defining a contact surface; and
at least one cell recessed into said polymeric layer, said at least one cell comprising a base and at least one wall extending between said contact surface and said base, wherein said at least one wall extends perpendicularly to said contact surface.

17. The contact cleaning surface according to claim 16, wherein said base extends perpendicularly to said at least one wall.

18. The contact cleaning surface according to claim 17, wherein a ratio between a surface area of said contact surface and a surface area of said base remains substantially the same as said contact surface contacts the contaminated substrate and wears during use.

19. The contact cleaning surface according to claim 17, wherein the surface area of said contact surface is in the range 10% to 80% of the total surface area of said contact cleaning surface.

20. The contact cleaning surface according to claim 16, wherein said at least one cell has at least one of a substantially circular footprint or a substantially polygonal footprint.

21. The contact cleaning surface according to claim 20, wherein said at least one cell has a substantially hexagonal footprint.

22. The contact cleaning surface according to claim 16, wherein said at least one cell has a depth of less than or equal to about 100 microns.

23. The contact cleaning surface according to claim 16, wherein said polymeric layer comprises an elastomeric material.

24. The contact cleaning surface according to claim 16, comprising a plurality of cells recessed into said polymeric layer, each cell being spaced apart by a portion of said contact surface.

25. The contact cleaning surface according to claim 24, wherein said plurality of cells are uniformly distributed across at least a portion, preferably substantially all, of said contact cleaning surface.

26. A contact cleaning roller, configured to at least one of collect or remove contaminating particles from a contaminated substrate, comprising a roll core having a contact cleaning surface according to claim 16.

27. The contact cleaning roller according to claim 26, wherein said roll core defines a longitudinal axis, and wherein said at least one wall extends substantially perpendicularly to said longitudinal axis.

28. A contact cleaning apparatus for at least one of collecting or removing contaminating particles from a contaminated substrate, comprising:
at least one contact cleaning roller comprising a roll core having a contact cleaning surface according claim 16; and
at least one adhesive roll comprising a roll core having at least one layer of adhesive material thereon, said at least one adhesive roll configured to at least one of collect or remove contaminating particles from said contact cleaning surface of said at least one contact cleaning roller.

29. A contact cleaning apparatus according to claim 28, comprising a pair of contact cleaning rollers and a pair of adhesive rolls, each contact cleaning roller separately configured to collect or remove contaminating particles from opposing surfaces of the contaminated substrate, and each adhesive roll being separately configured to at least one of collect or remove contaminating particles from each contact cleaning roller.

30. A method of at least one of collecting or removing contaminating particles from a contaminated substrate, the method comprising:
providing a contaminated substrate including contaminating particles thereon;
providing a contact cleaning surface according to claim 16; and
at least one of contacting or urging said contact cleaning surface against said contaminated substrate, such that at least some or substantially all of said contaminating particles on said contaminated substrate are at least one of collected or removed.
